(19) United States
(12) Patent Application Publication
(10) Pub. No.: US 2025/0153531 A1
(43) Pub. Date: May 15, 2025

(54) BALL JOINT STUD SENSING ASSEMBLY AND METHOD

(71) Applicant: Musashi Auto Parts Canada Inc., Waterloo (CA)

(72) Inventors: Usam Ayad Nasser, Guelph (CA); Kareem Hisham Abdelhafiz A Elrufaie, Kitchener (CA); Tyler Benson Veld, Listowel (CA); Wenxuan Lu, Kitchener (CA); Anthony Edward Meola, Guelph (CA)

(73) Assignee: Musashi Auto Parts Canada Inc., Waterloo, ON (CA)

(21) Appl. No.: 18/947,194

(22) Filed: Nov. 14, 2024

Related U.S. Application Data
(60) Provisional application No. 63/598,897, filed on Nov. 14, 2023.

(51) Int. Cl. B60G 17/019; B60G 7/00

(52) U.S. Cl. CPC B60G 17/01925; B60G 7/005; B60G 2204/116; B60G 2204/416

(57) ABSTRACT

Provided is a ball joint stud sensing assembly and method. A sensor package disposed in ball joint assembly includes a magnet at a first ball joint assembly component of the ball joint assembly, the magnet having a magnetic field, and a sensor at a second ball joint assembly component of the ball joint assembly, the sensor measuring fluctuations in the magnetic field, wherein the fluctuations indicate an oscillation and displacement of the first ball joint assembly component relative to the second ball joint assembly component.

### TECHNICAL FIELD

The following relates generally to ball joint assemblies, particularly to apparatuses and methods for sensing within ball joint assemblies.

### INTRODUCTION

A ball joint can provide a flexible connection between two components that allows movement of the components in more than one direction at the same time.

Ball joints play a critical role in the safe operation of, for example, automobile steering and suspension. Ball joints provide a safe, smooth ride and allow precise control of vehicles. If ball joints significantly wear or fail, the connected components may become unconstrained or disposed at an unintended angle. The results of this failure can be costly and dangerous.

For example, an automobile wheel may become unconstrained due to a failed or failing ball joint. Similarly, front and rear suspensions of a car are complex assemblies of links, joints, bushings and bearings that allow front wheels to move up and down independently and turn left or right together. Ball joints are used as a spherical bearing to connect control arms and steering links to the knuckle of a vehicle. By allowing multiple degrees of freedom (up to certain angle limits), ball joints enable the wheels (and knuckles) of the vehicle to turn and translate vertically. Ball joints of the front suspension provide pivoting movement between the steering knuckles and control arms. Worn ball joints contribute to looseness in the front suspension which may result in a tire being oriented at an unintended angle. This looseness often causes problems before they are noticeable by the driver such as when the vehicle is not maintaining wheel alignment. If the looseness is severe, the driver may notice steering looseness, steering vibration, or unusual noises.

Ball joint failures extend beyond inconvenience. Unconstrained wheels or misaligned tires may result in the tires not maintaining optimum contact with the road. This may contribute to excessive tire wear, shortening the life of expensive tires, and in some cases stud separation from the housing. This may also cause more sudden damage to tires, or in cases where debris is formed to other parts of the of the vehicle and the surroundings. They can also result in immediate loss of control of your vehicle including an abrupt halt of the vehicle, which may put everyone in danger.

Due to an often high and persistent working load, the ball joint assembly components, such as the ball joint bearing, typically wear during the normal course of operation. This can result in sub-optimal performance and the failures described above.

Avoiding such sub-optimal performance and potential failures can be costly and inconvenient. Replacing or repairing ball joints assemblies at optimal times may require obtaining information on the condition of the ball joint assembly. Existing methods and systems for inspecting the assembly, however, may be costly and may risk damage to the assembly or attached vehicle. For example, inspection may include disassembly of the ball joint assembly or parts of the vehicle it is installed. This disassembly and work to reassemble the parts risks damage and/or improper installation. Inspection, including the disassembly, may also require specialized equipment or may only be feasible at long intervals. Existing sensors that continuously measure wear rely on contact. These sensors often interfere with the operation of the ball joint assembly and only provide indication when a (often suboptimal) threshold is reached. Existing systems therefore, have very minimal and/or difficult to obtain safety indicators in place. Out of caution or concern for optimal performance, ball joint assemblies and components may be replaced or repaired more frequently than is optimal or necessary (i.e. before the end-of-life) to avoid such risks and costs.

Furthermore, ride height sensors of vehicles are used to measure a vehicle's ride height. Ride height is used in various ways including air suspension automatic level control and automatic headlight leveling systems. A common definition of ride height is the vertical distance between the bottom of the vehicle frame and the ground. Ride height relates to the suspension geometry of the vehicle. Typically, the ride height of the vehicle changes as a result of suspension movement.

Existing ride height sensors measure ride height by the angle of rotation of a suspension link on the vehicle. This sensor angle can then be correlated to ride height, depending on the measurement location and the kinematics of the suspension geometry. This type of sensor measures the rotational movement of the control arm in terms of an output voltage that is proportional to the rotation angle. The ride height is calculated based on the rotational movement and angular measurements and provided to the Electronic Control Unit (ECU) of the vehicle.

The ride height sensors are typically mounted to the frame of the vehicle and are attached to the control arm. Depending on the desired application, there could be 4 ride height sensors, one in each corner of the vehicle. These sensors, however, require mounts, fasteners, fixtures and assembly steps that increase costs and risks of potential failure. For example, these sensors may be installed incorrectly during assembly, maintenance, and replacement. Additionally, the sensors' disposition in the vehicle and lack of containment exposes these sensors to risk of shifting effecting calibration and inference or damage from environmental elements such as dirt, mud, and water, also known as contaminants.

Accordingly, there is a need for apparatuses and methods for determining the wear or durability of a ball joint and obtaining ride height of a vehicle which overcome difficulties of existing sensors.

### SUMMARY

Provided is a sensor package disposed in a ball joint assembly. The sensor package includes a magnet at a first ball joint assembly component of the ball joint assembly, the magnet having a magnetic field. The sensor package further includes a sensor at a second ball joint assembly component of the ball joint assembly, the sensor measuring fluctuations in the magnetic field. The fluctuations indicate one or more of an oscillation and a displacement of the first ball joint assembly component relative to the second ball joint assembly component.

The first ball joint assembly component may include a stud. The second ball joint assembly component may include a socket. The stud and socket may be rotatably connected.

The sensor package may be contained within a cavity of the ball joint assembly.

The sensor package may further include a printed circuit board (PCB) physically and communicatively connected to the sensor and disposed within the cavity. The PCB may be configured to receive an output of the sensor indicating the measured fluctuations and encode a signal based on at least one of the measured fluctuations.

The signal may include at least one of the measured fluctuations.

The signal may include one or more of a wear and displacement of the ball joint assembly determined based on at least one displacement fluctuation encoded in the signal. The displacement fluctuation may be a fluctuation value of the measured fluctuations indicating the displacement of the first ball joint component relative to the second ball joint component.

The signal may include one or more of a ride height of a vehicle at a suspension assembly of the vehicle comprising the ball joint assembly and an oscillation angle of the ball joint assembly determined based on at least one oscillation angle fluctuation encoded in the signal. The oscillation angle fluctuation may be a fluctuation value of the measured fluctuations indicating the oscillation of the first ball joint assembly component relative to the second ball joint assembly component.

Determining the wear may include applying the displacement fluctuation to a displacement calibration equation.

Determining the ride height at the suspension assembly may include applying the oscillation fluctuation to an oscillation angle calibration equation.

The PCB may be configured to determine one or more of a ride height of the vehicle at a point of interest and a payload capacity of the vehicle based on the ride height at the suspension assembly.

Determining the payload capacity may include applying payload or ride height fluctuation to a payload calibration equation.

The ball joint assembly may be disposed in a vehicle. The sensor package may be communicatively connected to an electronic control unit (ECU) of the vehicle. the sensor package may be configured to encode a signal based on the measured fluctuations of the signal indicating one or more of a wear of the ball joint assembly, a ride height of the vehicle, and a payload capacity of the vehicle one or more of approaching and exceeding a wear threshold, a predetermined ride height range and a predetermined maximum load capacity, respectively. The signal may be further configured to provide the signal to the ECU for generating a warning message based on the signal.

Provided is a method of determining a disposition of a ball joint assembly. The ball joint assembly includes a sensor package disposed in the ball joint assembly. The method includes installing the ball joint assembly in a vehicle and measuring, with the sensor package, one or more of the displacement and oscillation of the ball joint assembly.

The sensor package may include a magnet at a first ball joint assembly component of the ball joint assembly, the magnet having a magnetic field and a sensor at a second ball joint assembly component of the ball joint assembly, the sensor measuring fluctuations in the magnetic field, wherein the fluctuations indicate an oscillation or displacement of the first ball joint assembly component relative to the second ball joint assembly component.

The method may include encoding a signal based on at least one measured fluctuation. The signal may include the at least one measured fluctuation

The signal may include one or more of a wear and displacement of the ball joint assembly determined based on at least one displacement fluctuation encoded in the signal. The displacement fluctuation may be a fluctuation value of the measured fluctuations indicating the displacement of the first ball joint component relative to the second ball joint component.

The signal may include one or more of a ride height of a vehicle at a suspension assembly of the vehicle comprising the ball joint assembly and an oscillation angle of the ball joint assembly determined based on at least one oscillation angle fluctuation encoded in the signal. The oscillation angle fluctuation may be a fluctuation value of the measured fluctuations indicating the oscillation of the first ball joint assembly component relative to the second ball joint assembly component. The method may include providing the signal to an ECU of the vehicle.

Calculating one or more of the wear, displacement, ride height at the suspension assembly and oscillation angle may be by a PCB of the sensor package.

Calculating one or more of the wear, displacement, oscillation angle, ride height at the suspension assembly, ride height at a point of interest, and payload capacity may include applying at least one fluctuation to a calibration equation.

The method may include generating a warning message based on a measured fluctuation indicating one or more of the wear, a ride height of the vehicle, and a payload capacity of the vehicle one or more of approaching and exceeding a wear threshold, a predetermined ride height range and a predetermined maximum load capacity, respectively.

The message may be generated by an ECU of the vehicle.

The first ball joint assembly component may include a stud and the second ball joint assembly component may include a socket the stud and socket rotatably connected.

The sensor package may be contained within a cavity of the ball joint assembly.

The ball joint assembly may rotatably connect a first and second suspension component of a suspension assembly of the vehicle. The method may include determining an oscillation of the suspension assembly based on the measured oscillation.

The method may include determining one or more of a payload capacity of the vehicle and ride height or the vehicle at a point of interest based on at least one ride height at a suspension assembly of the vehicle including the ball joint assembly.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram of a vehicle including a ball joint assembly, according to an embodiment;

FIG. 2 is a block diagram of the ball joint assembly of FIG. 1, according to an embodiment;

FIG. 3A is a cut away schematic of the ball joint assembly of FIG. 1, according to an embodiment;

FIG. 3B is a cross sectional schematic of the ball joint assembly of FIG. 1, according to an embodiment;

FIG. 4A is a cross sectional schematic of the ball joint assembly of FIG. 1 in a nominal configuration with a corresponding nominal shaft position plot, according to an embodiment;

FIG. 4B is a cross sectional schematic of the ball joint assembly of FIG. 1 in an oscillated configuration with a corresponding oscillated shaft position plot, according to an embodiment;

FIG. 4C is a perspective view cut away schematic of the sensor package of FIG. 1, according to an embodiment;

FIG. 4D is a perspective view schematic of the sensor of FIG. 1, according to an embodiment;

FIG. 5A is a cut away schematic of the ball joint assembly of FIG. 1 in a new condition, according to an embodiment;

FIG. 5B is a cut away schematic of the ball joint assembly of FIG. 1 in a worn condition, according to an embodiment;

FIG. 5C is a plot illustrating the axial elasticity of the new ball joint assembly of FIG. 5A for a given peak to peak load, according to an embodiment;

FIG. 5D is a plot illustrating the axial elasticity of the worn ball joint assembly of FIG. 5B for the peak to peak load of FIG. 50, according to an embodiment;

FIG. 6A is a side view photograph of a suspension assembly of the suspension system of FIG. 1 in a raised configuration, according to an embodiment;

FIG. 6B is a side view schematic of a suspension assembly of the suspension system of FIG. 1 in a raised configuration, according to an embodiment;

FIG. 6C is a side view photograph of a suspension assembly of the suspension system of FIG. 1 in a lowered configuration, according to an embodiment;

FIG. 6D is a side view schematic of a suspension assembly of the suspension system of FIG. 1 in a lowered configuration, according to an embodiment;

FIG. 7 is side view schematic of the vehicle of FIG. 1, according to an embodiment;

FIG. 8A is a chart illustrating output oscillation angles of the ball joint assembly sensor package of FIG. 1 corresponding to induced reference oscillation angles, according to an embodiment;

FIG. 8B is a chart illustrating output displacements of the ball joint assembly sensor package of FIG. 1 corresponding to induced reference displacements, according to an embodiment;

FIG. 9 is a flow diagram of a method of determining the wear of the ball joint assembly of FIG. 1, according to an embodiment; and

FIG. 10 a method of determining a ride height of the vehicle of FIG. 1 at various points, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

A description of an embodiment with several components in contact or connection with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The present disclosure provides a sensor package of a ball joint assembly for measuring a displacement and oscillation angle of the ball joint assembly. Further provided is a method of determining wear of the ball joint assembly based on the measured displacement. Further provided is a method of determining ride height of a corresponding vehicle, at a location of the ball joint assembly based on the oscillation angle of the ball joint assembly and for determining ride heights of a vehicle at various points and a payload capacity of the vehicle based on ride heights at the location of the ball joint assembly.

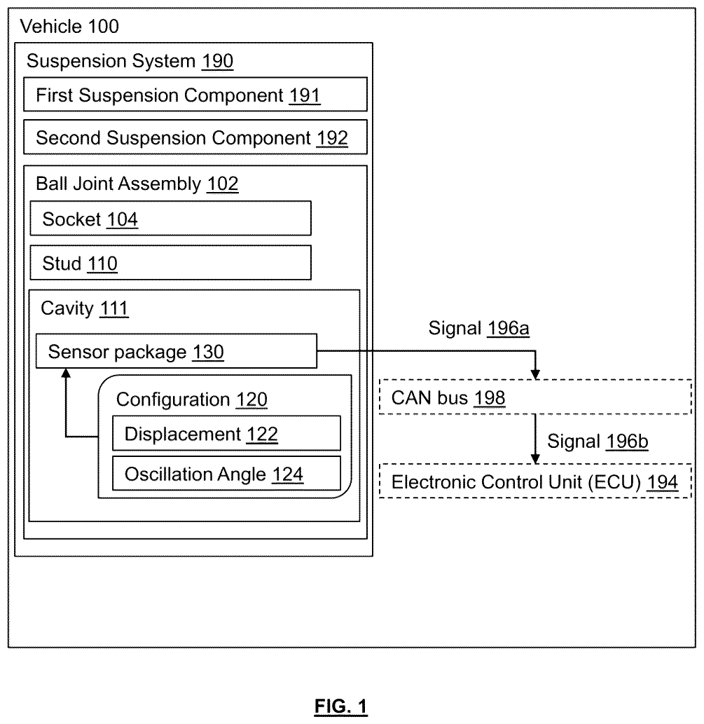

Referring to FIG. 1 shown therein a block diagram of a vehicle 100 including a ball joint assembly 102, according to an embodiment. Specifically, the ball joint assembly 102 is installed as a component of a suspension system 190 of an automotive vehicle 100.

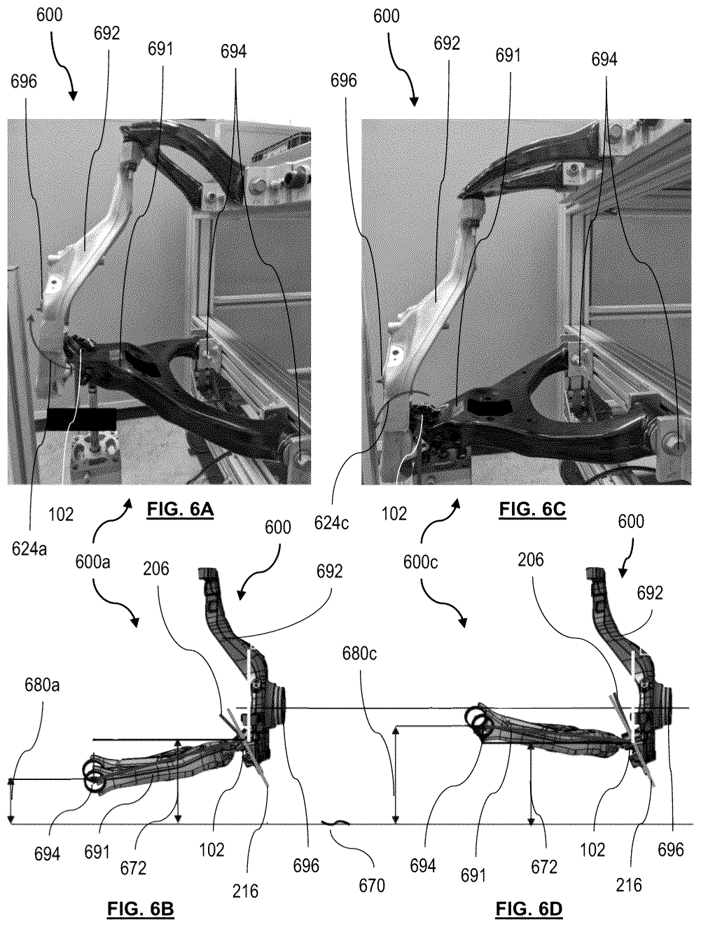

The ball joint assembly 102 rotatably connects a first suspension component 191 and a second suspension component 192 of the suspension system 190. For example, the ball joint assembly 102 may rotatably connect an automotive suspension assembly knuckle and control arm such as the arm 691 and knuckle 692, respectively of FIGS. 6A through 6D.

A wear of the ball joint assembly 102, also known as a condition of the ball joint assembly 102, can be determined based on a displacement 122 of the ball joint assembly 102, further described below. A ride height and a payload capacity of the vehicle 100 can be determined based on an oscillation angle 124, further described below, of one or more ball joint assemblies 102.

The ball joint assembly 102 includes a socket 104. The socket 104 may further be referred to and known as the base 104 or housing 104. The socket 104 serves as a receptacle for the stud 110, further described below.

The ball joint assembly 102 further includes the stud 110. The stud 110 is rotatably connected to and at least partially disposed in the socket 104. The rotational degrees of freedom between the stud 110 and the socket 104 provide the rotatable connection of the ball joint assembly 102.

The configuration 120 of the ball joint assembly 102 is, at least partially, defined by and may be determined based on the disposition of the stud 110 relative to the socket 104. The configuration 120 includes a displacement 122 and oscillation angle 124 of the stud 110 relative to the socket 104, further described below.

Wear of the ball joint assembly 102, ride heights of the vehicle 100, and payload capacity of the vehicle 100 are determined based on the configuration 120 and a geometry of the suspension system 190. It will be appreciated that the geometry of the suspension may include many additional suspension components, the geometry of which must be considered when trying to determine ride heights of the vehicle 100 and payload capacity of the vehicle 100 based on the configuration 120. For example, in a conventional double wishbone suspension system as shown in FIGS. 6A and 6C, the geometry of the upper arm, lower arm 691, and knuckle 696 is required in order to determine oscillation angle 124, and therefore the ride height value and payload value. Wear is determined based on the displacement 122, further described below. The ride height of the vehicle 100 near a corresponding ball joint assembly 102 is determined based on an oscillation angle 124 of the ball joint assembly 102 and a geometry of the suspension system 190, further described below. Ride heights of the vehicle 100 at various points of interest and payload capacity of the vehicle 100 are determined based on ride height of multiple ball joint assemblies 102, and a geometry of the vehicle 100, further described below.

The ball joint assembly 102 further includes a sensor package 130. The sensor package 130 measures the displacement 122 and oscillation angle 124 of the stud 110 relative to the socket 104.

The sensor package 130 encodes the measurements, such as but not limited to, displacement 122, oscillation angle 124, magnetic field values measured by the sensor 236 of the sensor package 130, or any combination thereof in a signal 196.

The sensor package 130 may provide the signal 196 to the ECU 194 via a controlled area network (CAN) bus 198. The CAN bus 198 is typically a CAN bus 198 of the vehicle the ball joint assembly 102 is installed on. The post-processed oscillation angle 124 and displacement 122 measurements are output through the CAN bus 198 network to allow for ease of automotive integration. The CAN bus 198 is a message-based communication protocol that is designed to allow ECUs 194 and other devices to communicate with each other reliably and in a priority driven way. Frames with distinct ID numbers, and bytes of data, are received by all devices in the network without requiring a host computer.

In some embodiments, the sensor package 130 is communicatively connected to an electronic control unit (ECU) 194 of the vehicle 100. The sensor package 130 provides a signal 196 to the ECU 194. To interface with the vehicle 100, four (4) wires attached to a connector of the sensor package 130. The four wires facilitate power and CAN bus 198 communication. The connector may be an industry standard 4 pin connector to allow for interfacing with the sensor package 130 as well as ease of integration into existing automotive systems.

The sensor package 130 is disposed within a cavity 111 of the ball joint assembly 102. The cavity 111 may be an interior cavity of the socket 104. This cavity 111 is sealed off to prevent any contaminants from contacting the circuitry of the sensor package 130 to prevent any potential damage to the electronics. Disposing the sensor in the cavity 111 also protects the sensor from environmental elements such as water, dust, and mud. It also reduces installation to a single contained critical unit (the ball joint assembly 102). This simplifies installation and improves the likelihood of proper installation reducing time and costs of installation (i.e. plug and play).

Utilizing the sensor package 130 disposed in the ball joint assembly 102 to determine wear beneficially provides a continuous, contactless, and accessible assessment of the condition of the ball joint assembly. This beneficially minimizes risks, costs, and inconveniences associated with inspecting the ball joint assembly. It also beneficially improves safety by providing an active awareness of the condition both prior to and when maintenance is recommended. This beneficially facilitates maintenance planning, optimizes replace efforts and reduces incentives of avoiding replacement by minimizing sub-optimal preventative replacements.

Utilizing the sensor package 130 disposed in the ball joint assembly 102 to determine ride heights beneficially eliminates or mitigates the bulk, weight, maintenance, and installation of existing ride height sensors. The effect is multiplied over each sensor eliminated; a factor of four or more in typical vehicles.

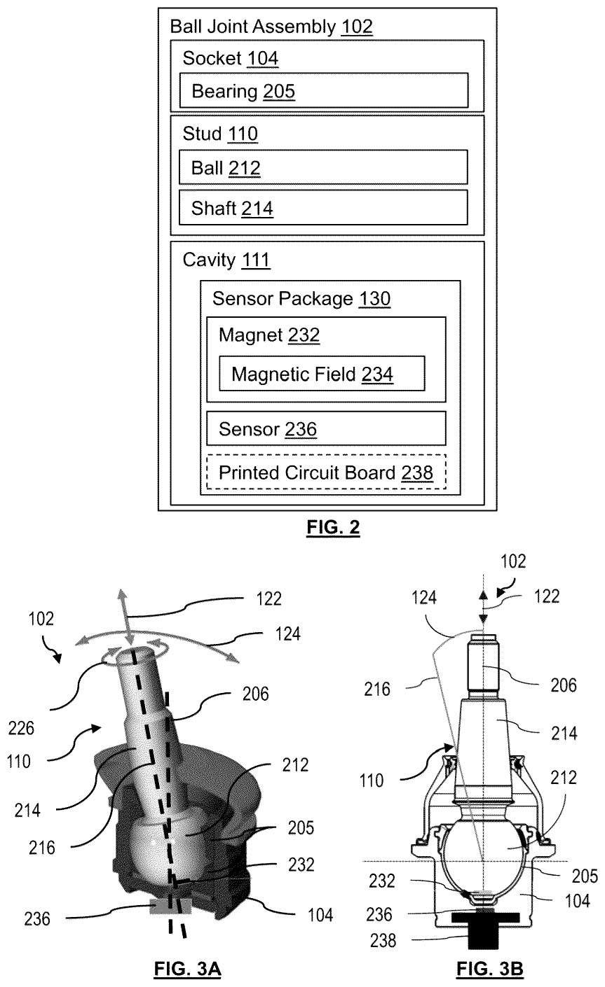

Referring to FIGS. 2, 3A and 3B, shown therein is a block diagram, cut away schematic, and cross sectional schematic of a ball joint assembly 102, according to an embodiment.

The ball joint assembly 102 includes the socket 104. The socket 104 has a socket axis 206. The socket axis 206 is an axis through the longitudinal center of the socket 104. The socket 104 is fixedly connected to the first suspension component 191 of FIG. 1. In some embodiments, the socket 104 includes a bearing 205. The bearing 205 provides an interface between the socket 104 and the stud 110, further described below. The bearing 205 may be composed of materials that accommodate movement between the socket 104 and the stud 110, such as plastic or metallic or ceramic materials. The materials of the ball joint assembly 102 may be anti-magnetic or coated with an anti-magnetic coating. This composition or coating may reduce magnetic interference caused by components of the ball joint assembly 102. Reducing the magnetic interference may beneficially increase the accuracy of the sensor package 130, where the sensor package 130 includes a magnetic sensor 236.

The ball joint assembly 102 includes the stud 110. The stud 110 has a stud axis 216. The stud axis 216 is an axis through the longitudinal center of the stud 110. The stud 110 is fixedly connected to the second suspension component 192 of FIG. 1.

The stud 110 includes a ball 212. The ball 212 is a frustro-spherical portion of the stud 110 disposed at a first end of the stud 110. The stud 110 further includes a shaft 214. The shaft 214 may be referred to or known as the taper 214 and tapered shaft 214. The shaft 214 is a substantially cylindrical or tapered portion of the stud 110. The shaft 214 is connected to the ball 212 and disposed at a second end of the stud 110. The stud 110 is rotatably connected to the second suspension component 192 of FIG. 1. The connection is via the shaft 214.

The rotatable connection of the stud 110 and socket 104 accommodates movement of the stud 110 along and about multiple axes. For example, the stud 110 oscillates at an oscillation angle 124 about the socket axis 206. The stud 110 may also rotate a rotation 226 about the stud axis 216. The stud 110 may also displace a displacement 122 along the stud axis 216. The displacement 122 may be due to wear of the ball joint assembly 102, specifically wear of the bearing 205.

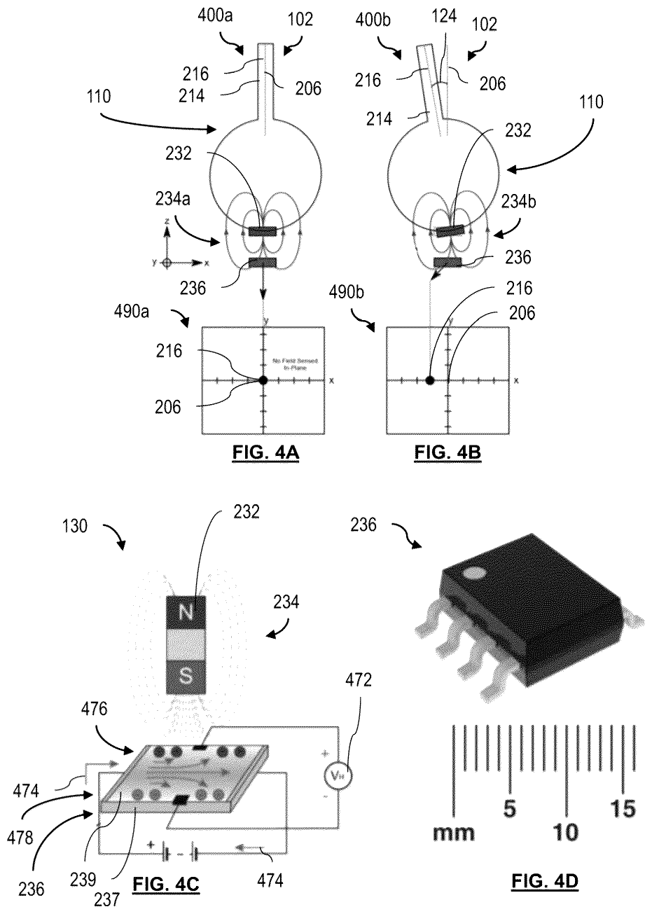

Referring also to FIGS. 4A and 4B, shown therein is cross-sectional schematic of a ball joint assembly 102 in a nominal configuration 400a with a corresponding nominal shaft position plot 490a and an oscillated configuration 400b with a corresponding oscillated shaft position plot 490b, according to an embodiment. The shaft position plots 490 are a top view cross section of the ball joint assembly 102. The shaft position plots 490 indicate a position of the stud axis 216 relative to the socket axis 206. The socket axis 206 is located at the origin of each shaft position plot 490.

In the nominal configuration 400a, the stud axis 216 and socket axis 206 are aligned. The nominal shaft position plot 490a shows the shaft axis 216 is centered at the socket axis 206 in this configuration 400a.

In the oscillated configuration 400b, the stud axis 216 and socket axis 206 are misaligned. The magnitude of the misalignment is the oscillation angle 124. The oscillated shaft position plot 490b shows the shaft axis 216 is off center relative to the socket axis 206 in the oscillated configuration 490b.

The ball joint assembly 102 further includes the sensor package 130. The sensor package 130 is contained within the cavity 111.

Referring also to FIG. 4C shown therein is a perspective view cut away schematic of a sensor package 130 according to an embodiment. The sensor package 130 includes a magnet 232. The magnet 232 provides a magnetic field 234. An oscillation and displacement of the magnet 232 may be calculated based on detected and/or measured changes, also known as fluctuations, in the magnetic field 234. The displacement 122 and oscillation angle 124 of the stud 110 may be calculated based on the oscillation and displacement of the magnet relative to the sensor 236 and a geometry of the ball joint assembly 102. The geometry of the ball joint assembly 102 includes the relative disposition of the magnet 232, sensor 236, socket 104, and stud 110 in a nominal configuration.

The magnet 232 is physically connected to the ball 212. As the ball 212 displaces and/or oscillates, the position and orientation of the magnet 232 changes accordingly. Fluctuations in the magnetic field 232, based on these dispositions, indicate the displacement 122 and oscillation angle 124.

The magnet 232 is disposed at the top of the ball 212; the part of the ball 212 furthest from the shaft 214. In some embodiments, the magnet 232 is press fit in the ball 212. In some embodiments, the magnet 232 is embedded in the ball 212 such that magnet 232 is at least partially exposed outside of the ball 212.

The sensor package 130 further includes the sensor 236.

Referring also to FIG. 4D shown therein is a perspective view schematic of a sensor 236, according to an embodiment. The sensor 236 is configured to measure the fluctuations in the strength of the magnetic field 234. The fluctuations are in the form of magnetic flux density. The sensor 236 may be a 3D magnetic sensor. A 3D magnetic sensor measures the strength of a magnetic field on the X-, Y-, and Z-axes. The 3 axes magnetic flux densities allow the magnetic sensor 236 to detect the rotation, oscillation, and translation of a magnet 232 and a connected object such as the stud 110. These measurements may be correlated to linear and angular movements of the magnet 232. These movements correspond to the displacement 122 and oscillation angle 124, respectively, of FIG. 1. The 3D magnetic sensor 236 may be a QFN16, TSSOP16, or SOIC8 package.

In an example, the sensor 236 measures the asymmetry of the magnetic field 234b relative to the sensor 236 in the oscillated configuration 490b. This asymmetry, particularly relative to the symmetrical or non-present magnetic field 234a of the nominal configuration 490a, indicates that the stud 110 is oscillated relative to nominal in the oscillated configuration 490b. The vector (magnitude and direction) of the asymmetry indicate the vector of the oscillation angle 124.

Referring specifically to FIG. 4C, the sensor 236 may be a Hall Effect sensor. The Hall Effect sensors output a measurable voltage 472 based on magnetic field 234 fluctuations. The measurable voltage 472 is induced in a flat conductor 237. The flat conductor is disposed opposite and substantially normal to the magnet 232. The flat conductor 237 includes charge carriers 239. The charge carriers 239 allow current 474 to flow through the conductor 237. Current 474 is disrupted corresponding to the fluctuation in the magnetic field 234. The disruption results in the protons 476 and electrons 478 of the charge carrier 239 to jump to opposite sides of the charge carrier 239 inducing the voltage 472. The induced voltage 472 is measurable and indicates the flux densities. The sensor 236 is configured to encode the measured voltage 472 in the signal 196 of FIG. 1. The sensor 236 may provide the signal 196 to the ECU 194 of FIG. 1.

The magnetic sensor 236 may be a dual die sensor 236. Dual die sensors 236 include two sensors 236 in one package. The two sensors 236 providing redundancy for demanding applications. It will be appreciated that the magnetic sensor 236 may include any number of sensors such as a system of sensors. Measuring magnetic field 234 flux density values using a single die sensor 236 allows for an easier orientation and any offset calibration due to the symmetric nature of the device. Simpler applications benefit from single die sensors 236 as proper orientation is easy to achieve and calibration is made easier than with dual die sensors 236. More demanding and critical applications may have some redundancy as a backup if one sensor 236 were to fail.

Referring again to FIGS. 3A through 4B, the sensor 236 is physically connected to the socket 104. The sensor 236 is disposed substantially opposite to the magnet 232. This disposition optimizes sensor package 130 performance and accuracy. It is expressly contemplated that the dispositions of the magnet 232 and sensor may be swapped such that the magnet 232 connected to the socket 104 and the sensor 236 is connected to the ball 212.

Referring back to FIGS. 1 and 2, in some embodiments, the sensor package 130 includes a printed circuit board (PCB) 238. The PCB 238 is configured in a custom PCB design that includes only chips and integrated controllers for the sensor package 130. The PCB is configured to fit into the ball joint assembly 102. This fit accommodates manufacturing and packaging. The PCB 238 is communicatively connected to the sensor 236 and the ECU 194. The PCB 238 receives the signal 196a from the sensor 236 and provides the signal 196b, based on the signal 19a, to the ECU 194. The PCB 238 may serve as a coupler between the sensor 236 and the ECU 194. For example, in some embodiments, the PCB 238 may accommodate differences in connector or signal type between the sensor and the ECU 194. The connection between the PCB 238 and the ECU 194 may be via a DB 9 connector.

In some embodiments, the PCB 238 may calculate and encode in the signal 196b aspects of the ball joint assembly 102 or corresponding suspension assembly 600 of FIGS. 6A through 6C based on the signal 196a. For example, these aspects may include displacement, oscillation angle, wear or ride height of the ball joint assembly 102 or corresponding suspension assembly 600. It will be appreciated that the signal 196b may include any combination of determined aspects and data of the signal 196a.

### Determining Wear

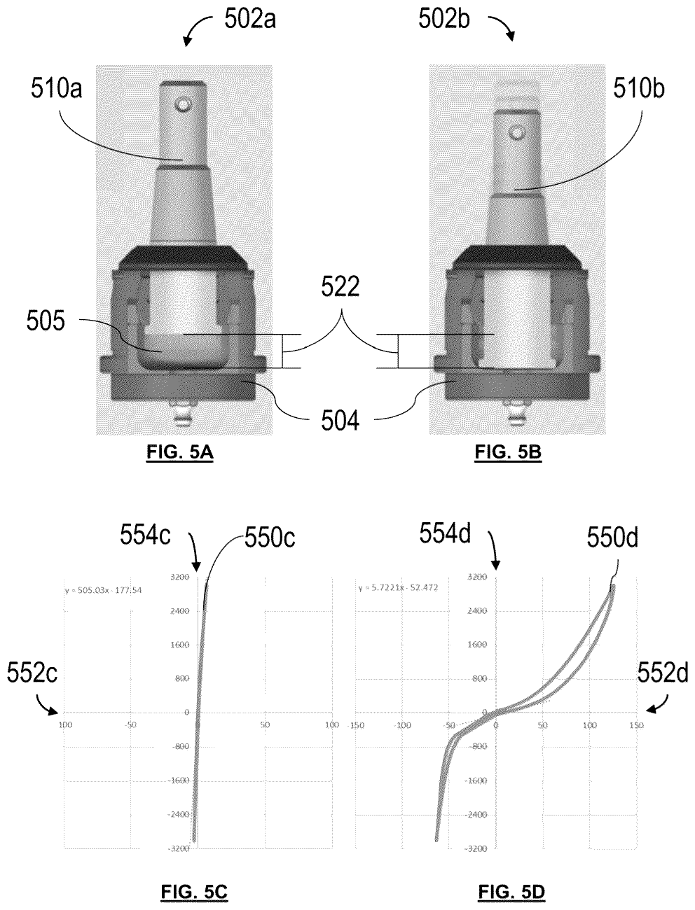

Referring to FIGS. 5A and 5B, shown therein is a cut away schematic of a new ball joint assembly 502a and a worn ball joint assembly 502b, respectively, according to an embodiment. The ball joint assemblies 502a and 502b are referred to generically as ball joint assembly 502. It will be appreciated the new ball joint assembly 502a and the worn ball joint assembly 502b may be the same ball joint assembly 502 in a new condition and a worn condition, respectively. The ball joint assembly 502 and parts thereof may be similarly configured to the ball joint assembly 102 of FIG. 2.

The stud 510 is displaced lower in the socket 504 in the worn ball joint assembly 502b than in the new ball joint assembly 502b. This displacement 522 may be the result of wear of the ball joint assembly 502. The wearing of the ball joint assembly 502 may include wearing away or degradation of material. Typically wear occurs in the bearing 505. It will be appreciated that the bearing 505 may wear partially or completely, as shown in FIG. 5B. This displacement 522 disposes the stud 510 closer to the socket 504 in the worn ball joint assembly 502b than in the new ball joint assembly 502a. This displacement 522 indicates the elasticity, also known as lash, of the ball joint assembly 502. The elasticity indicates the performance, durability and wear of the ball joint assembly 502. High elasticity typically corresponds to better and/or more predictable handling characteristics and ride quality for the vehicle occupants.

Changes in the elasticity of the ball joint assembly 502 over time are indicative of wear of the ball joint assembly 502 (typically the bearing component 505) and can be correlated to a damage criteria. When the elasticity value exceeds the upper safety limit, the ball joint assembly 502 may be characterized as fully-worn. Maintenance or replacement may be implemented or deemed necessary based on the determined wear.

The constant monitoring of the ball joint assembly 502 for wear improves the safety and handling of the vehicle, particularly long term occupant safety. It also avoids costly, often premature, preventative maintenance (replacement and repair) and mitigates the need for invasive and potentially destructive inspection. This is especially helpful for fleet vehicles where the drivers are constantly changing, and owners may be unaware of degradation of vehicle performance. A constant warning that informs the vehicle owner of the condition of the ball joint assembly 502 without the need for a driver to evaluate vehicle steering and performance or periodic inspection. This mitigates the potential for unexpected vehicle performance and handling such as vehicle situations that a driver or automated system may not be able to handle. This beneficially minimizes collisions and other vehicle incidents.

Continuous monitoring of the ball joint assembly 502 further enables predictive part ordering and repairing. The data obtained can be used to improve models that predict when a ball joint assembly 502 will fail. This may reduce premature replacement of ball joint assemblies 502.

Referring also to FIGS. 5C and 5D, shown therein are plots illustrating axial elasticity curves 550c and 550d of a new and a worn ball joint assembly, respectively. The new and worn ball joint assemblies may be the new ball joint assembly 502a and worn ball joint assembly 502b, respectively. The axial elasticity curves 550c and 550d, illustrate the displacement of the stud 510 on the x-axes 552c and 552d, respectively, relative to a peak to peak load indicated on the y-axes 554c and 554d, respectively.

The low displacement shown in the new axial elasticity curve 550c relative to the displacement shown in the worn axial elasticity curve 550d illustrates the low displacement of a new ball joint assembly 502a relative to a worn ball joint assembly 502b for the same peak to peak load. The high slope of the axial elasticity curve 550c relative to the slope of the worn axial elasticity curve 550d also indicates a high stiffness of the new ball joint assembly 502a over the worn ball joint assembly 502b.

The higher displacement and lower stiffness illustrated in the worn axial elastic curve 550d both indicate wear of the ball joint assembly 502. For example, where the ball 512 is fully enveloped by the bearing 505 the stud 510 will be stiff and displace less in the socket 504 for a given load. As the bearing 505 wears the stud 510 will displace more and be less stiff in the socket 504 for the same load. A new ball joint typically meets a maximum displacement and minimum stiffness requirements. A ball joint assembly 502 is determined to be worn based on if an increased displacement exceeds a maximum allowed displacement and/or the slope of the axial elastic curve 550 (indicative of stiffness) falls below a minimum slope limit. It will be appreciated each of the displacement and slope limits may be variable. For example, the maximum allowed displacement may be dependent on the stiffness of ball joint assembly 502.

### Determining Ride Height and Payload Capacity

Referring to FIGS. 6A and 6B shown therein is a side view photograph and schematic diagram of a suspension assembly 600 in a raised configuration 600a, according to an embodiment. Referring also to FIGS. 6C and 6D shown therein is a side view photograph and schematic diagram of the suspension assembly 600 in lowered configuration 600c, according to an embodiment. The suspension assembly 600 is a component of a suspension system of a vehicle such as the suspension system 190 and vehicle 100 of FIG. 1.

The suspension assembly 600 includes an arm 691. The arm 691 may be the first suspension component 191 of FIG. 1. The arm 691 is also known as a control arm 691. Where each suspension assembly 600 includes multiple arms 691, such as shown in FIGS. 6A and 6C, the arms 691 may be referred to by its relative location. For example, arm 691 may be referred to as lower arm 691 or upper arm 691. While the following description is with regard to a lower arm 691, it will be appreciated that the subject matter may similarly apply to any similar components of the suspension assembly 600 which are rotatably connected by a ball joint assembly 102. For example, the description may apply to an upper arm 691 of a suspension assembly 600.

The arm 691 is physically connectable to a frame of a vehicle such as the vehicle 100 of FIG. 1. Where a vehicle interface 694 is referred to herein, the vehicle interface 694 is understood to be a center of an interface between the arm 691 and the vehicle.

The suspension assembly 600 further includes a knuckle 692. The knuckle 692 may be the second suspension component 192 of FIG. 1. The knuckle 692 is physically connectable to a wheel of the vehicle. Where a wheel center 696 is referred to herein, the wheel center 696 is understood to be the center of the connection between the knuckle 692 and the wheel.

The suspension assembly 600 includes a ball joint assembly 102. The ball joint assembly 102, rotatably connects the arm 691 and the knuckle 692. The arm 691 is fixedly connected to the socket (hidden) of the ball joint assembly 600. The knuckle 692 is fixedly connected to the stud (hidden) of the ball joint assembly 600.

As the arm 691 oscillates relative to the knuckle 692 the stud axis 216 oscillates relative to the socket axis 206. The corresponding relative oscillation of the magnet axis and hall sensor axis may be measured as described above to obtain an oscillation angle 624.

A ride height 680 of the suspension assembly 600 may be determined based on the oscillation angle 624. It will be appreciated that the ride height 680 of the suspension assembly 600, as referred to herein, is the distance between the ground 670 and the vehicle interface 694.

Determining the ride height 680 is further based on the geometry of the suspension assembly 600. For example, the ride height 680 is based on a ball joint assembly height 672. The ball joint assembly height 672 is the height of the ball joint assembly 102 above the ground 670. The ball joint assembly height 672 may be predetermined based on an offset from the wheel center 696 height. The ride height 680 may be based on the length and mounting locations of the control arm 691 and knuckle 692. The ball joint assembly height 672 may further be based on additional components of the suspension assembly 600 such as additional linkages. The ride height 680 can be correlated to the ball joint oscillation angle 624 either experimentally or theoretically by solving the equations governing the suspension kinematics. It will be appreciated that the ball joint assembly height 672 and resulting calculated ride height 680 may be affected by factors such as an orientation of the knuckle 692 or tire radius correlating to wheel center 696 height. The ride height 680 may further be based on a length of the arm 691 (i.e. the distance between the ball joint assembly 102 and the vehicle interface 694).

In the raised configuration 600a the wheel center 696 is higher (i.e. raised) relative to the interface 694 compared to the in lowered configuration 600c. In this configuration 600a the ride height 680a is lower compared to the ride height 680c in the lowered configuration 600c.

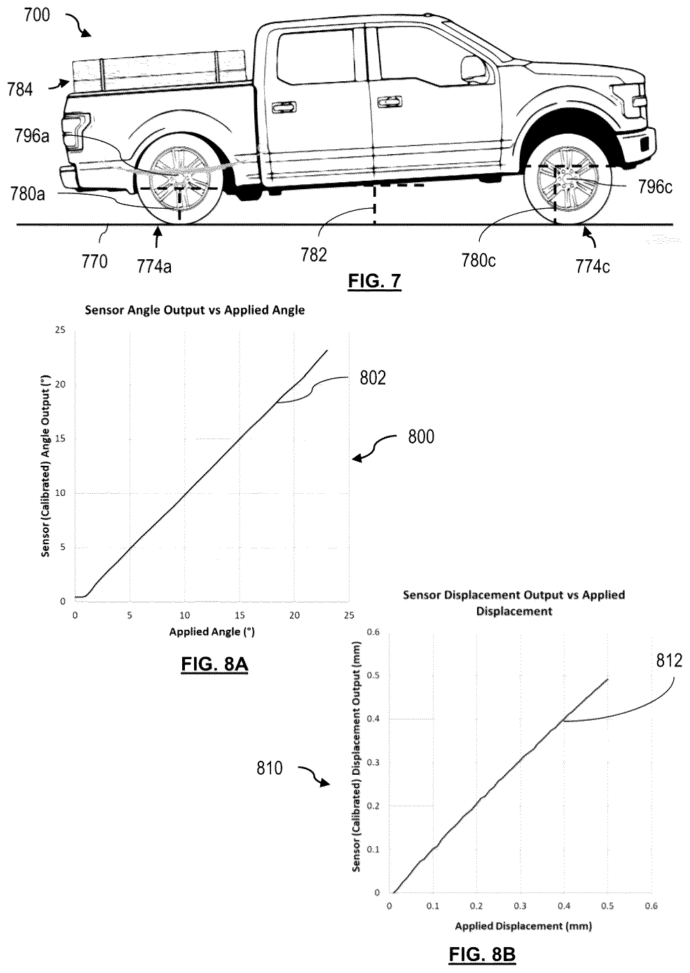

Referring also to FIG. 7, shown therein is a side view schematic of a vehicle 700, according to an embodiment. The vehicle 700 may be the vehicle 100 of FIG. 1, according to an embodiment.

The vehicle 700 contacts the ground 770 via wheels 774a and 774c. It will be appreciated that wheels 774, as referred to herein include the corresponding tire. Each wheel 774a and 774c is attached to the vehicle 700 via a corresponding suspension assembly 600. The ride height 780 of the vehicle 700 at each wheel 774a and 774c, is referred to herein as wheel ride height 780a and 780c respectively. Each wheel ride height 780 may be determined based on the ride height 680 of the corresponding suspension assembly 600. The suspension assembly 600 corresponding to the wheel 774a may be in the raised configuration 600a. The suspension assembly 600c corresponding to the wheel 774c may be in the lowered configuration 600c. It will be appreciated that additional wheel ride heights 780 may be determined for additional wheels 774 (not shown) such as wheels on the other side of the vehicle.

Referring specifically to FIG. 7, a calculated ride height 782 can be determined based on a wheel ride height 780 and the geometry of the vehicle 700 and/or at least one additional wheel ride height 780. The calculated ride height 782 is a ride height of the vehicle 700 at a point of interest of the vehicle 700. For example, the calculated ride height may be a ride height at the center of the vehicle 700, the center of the wheelbase and/or track of the vehicle 700, the center of mass of the vehicle 700, a front or rear end of the vehicle 700, a low or high point of the vehicle 700 when the vehicle 700 is on a level surface, and the like. The location on the vehicle 700 of the point of interest may vary based on environmental conditions and vehicle parameters such as tire inflation. In an example, where the point of interest is a location of the vehicle closest to the ground (i.e. the ground clearance or minimum ride height) the location the calculated ride height 782 is calculated at may vary based for example on an incline of the ground and/or a loading/balancing of the vehicle.

The payload capacity 784 of the vehicle 700 can be determined based on a wheel ride height 780 and the geometry of the vehicle 700 and/or at least one additional wheel ride height 780. In an example, the payload capacity 784 is determined based on a pitch of the vehicle 700. The pitch is calculated based on the difference in wheel ride heights 780a and 780c and the wheelbase of the vehicle 700 (the distance between wheel centers 796a and 796c). Where the ride heights 780a and 780c indicate that the payload capacity 784 is excessive (i.e. exceeds recommendation) a warning in a dashboard of the vehicle 700 may be generated by for example an ECU 194 of FIG. 1.

Referring to FIG. 8A show therein is a chart 800 illustrating output calibrated oscillation angles of a ball joint assembly sensor package corresponding to induced reference oscillation angles 802, according to an embodiment. Determining the oscillation angle 624 of FIGS. 6A through 6D is optimized by calibrating the sensor to the corresponding suspension assembly 600 of FIGS. 6A through 6D. To calibrate the sensor, a calibration equation is derived based on a correlation between various applied reference angles and corresponding measurements indicating oscillation angles output by the sensor, such as magnetic field fluctuation values. The calibration equation is applied to sensor measurements of a ball joint assembly including the sensor to determine oscillation angles of the corresponding suspension assembly. For example, oscillation angles measured by installed ball joint assemblies 102 of FIG. 1 are input to the calibration equation to determine oscillation angles of the suspension assembly and the corresponding ride heights. It will be appreciated that in some embodiments the calibration equation of a test ball joint assembly may be applied to ball joint assemblies of similar configuration and/or application for example in applications where batch calibration is sufficient.

The output calibrated oscillation angles shown are calibrated angles output by a ball joint assembly sensor package such as the sensor package 130 of FIGS. 2 through 4D. The reference angles are angles of the ball joint assembly induced by a calibration device. The calibration device may be a torque machine and/or a variable-speed rotational displacement machine. The variable-speed rotational displacement machine oscillates the ball joint assembly in various planes to precise angles. The calibration planes may be based on the setup of the calibration device.

The sensor indicated ride height values are shown by the correspondence of the results 802 to have been experimentally validated. Ball joint oscillation angles have resulted in high angle accuracy via the calibration. The high oscillation angle accuracy directly carries over to ride height accuracy.

Referring to FIG. 8B shown therein is a chart 810 illustrating output calibrated displacements of a ball joint assembly sensor package corresponding to induced reference displacements 812. Determining the displacement 522 of FIGS. 5A through 5D is optimized by calibrating the sensor 504. To calibrate the sensor, a calibration equation is derived based on a correlation between an applied reference displacement and a corresponding measurement indicating displacement output by the sensor. The calibration equation is applied to sensor measurements of a ball joint assembly including the sensor to determine displacements and corresponding wear of the ball joint assembly. For example, displacements measured by installed ball joint assemblies 102 of FIG. 1 are input to the calibration equation to determine calibrated displacements and the corresponding wear. It will be appreciated that in some embodiments the calibration equation of a test ball joint assembly may be applied ball joint assemblies of similar configuration and/or application for example in applications where batch calibration is sufficient.

The output calibrated displacements shown are calibrated displacements output by a ball joint assembly sensor package such as the sensor package 130 of FIGS. 2 through 4D. The reference displacements are displacements of the ball joint assembly at various stud heights. The reference displacements are induced by a calibration device. The calibration device displaces the ball joint stud vertically, for example in micrometer increments. The magnetic field value in the stud axial direction (z axis) is measured and reported at each stud height. The magnetic field values are used to correlate between the stud height and reported magnetic field.

The sensor indicated displacement values are shown by the correspondence of the results 812 to have been experimentally validated. Displacement values have resulted in a high displacement accuracy via the calibration.

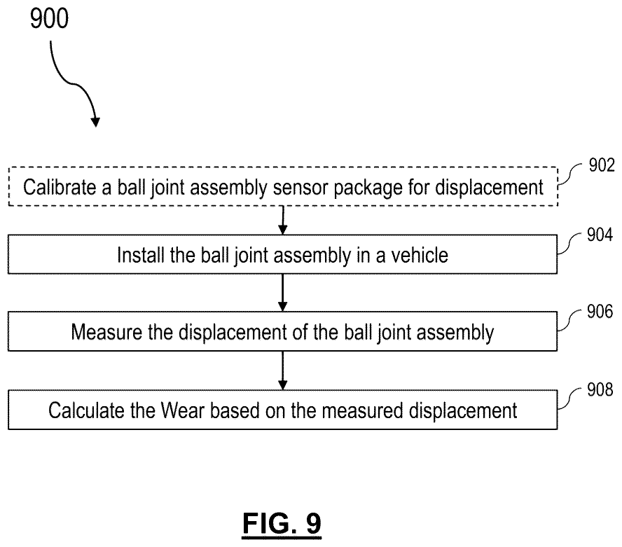

Referring to FIG. 9, shown therein is a flow diagram 900 of a method determining the wear of a ball joint assembly, according to an embodiment. The ball joint assembly may be the ball joint assembly 102 of FIG. 1.

At 902, determining the wear may include calibrating a sensor package of the ball joint assembly for displacement. The sensor package may be the sensor package 130 of FIG. 1. Calibrating the sensor package for displacement includes deriving a calibration equation for the ball joint assembly. The calibration equation is derived by disposing the ball joint assembly in a calibration device. The calibration device displaces the ball joint stud vertically, for example in micrometer increments. The magnetic field value in the stud axial direction (z axis) is measured and reported at each stud height. The magnetic field values are used to determine a correlation between the reference stud heights and reported magnetic field values. The calibration equation is derived based on the correlation.

In some embodiments, the calibration equation is derived by obtaining a displacement correlation for the ball joint assembly being calibrated. In some embodiments the calibration equation is derived by obtaining a displacement correlation of a first ball joint assembly and applying the corresponding calibration equation to a second ball joint assembly of similar configuration. For example, first ball joint assembly and second ball joint assembly may be ball joint assemblies of the same dimensions, batch, model, or line of ball joint assemblies.

At 904, determining the wear includes installing the ball joint assembly on a vehicle. The vehicle may be the vehicle 100 of FIG. 1. Specifically, the ball joint assembly is installed as part of a suspension assembly of the vehicle. Installing the ball joint assembly may include communicatively connecting the sensor package of the ball joint assembly to an ECU of the vehicle.

At 906, determining the wear includes measuring the displacement of the stud of the ball joint assembly. The measuring is via the sensor package. In some embodiments, the measuring is of a sensor voltage. The sensor voltage is induced in the sensor by fluctuations in a magnetic field of sensor package. The fluctuations indicate displacement of the stud. The measuring may be at regular intervals and/or triggered by various events, such as starting the vehicle. The measuring may occur while the vehicle is in use (i.e. in transit). The sensor package encodes the measured displacement value in a signal. The measured displacement value may be encoded as a magnitude of the sensor voltage.

At 908, determining the wear includes calculating the wear based on the measured displacement value. It is expressly contemplated that calculating the wear does not necessarily include calculating a wear value. For example, calculating the wear may be calculating if the wear is approaching or exceeds a wear threshold.

In some embodiments, calculating the wear includes obtaining a calibrated displacement or calibrated wear value by applying the measured displacement values, sensor voltage, and/or magnetic field fluctuation values to a calibration equation. The calibration equation may be the calibration equation derived at 902. Which value is applied is based on the expected input of the calibration equation. A calibrated displacement and/or a corresponding wear of the ball joint assembly is determined as a result of the application.

In some embodiments the calculations are performed by a PCB of the corresponding ball joint assembly, particularly a microchip of the PCB. In these embodiments, the PCB calculates the calibrated displacement and/or wear based on the measured displacement value (i.e. the sensor voltage).

The PCB initiates messages indicating the calculated wear or displacement. In an example, the displacement is compared to the maximum allowed limit of displacement. Where the displacement exceeds the limit, the PCB initiates an error message. It will be appreciated that the displacement may be the measured displacement value (i.e. the sensor voltage) or the calibrated displacement value corresponding to the basis of the limit. In a further example, the PCB determines a wear based on the displacement and/or stiffness and initiates an update message indicating the wear. The message may also include an indication of if the determined wear is approaching or exceeds a wear threshold.

The PCB sends a signal including at least one message to the ECU. The signal may be sent through a CAN Bus network to the ECU.

The ECU may inform the driver based on the message received. For example, where the determined wear exceeds and/or approaches a wear threshold, a maintenance message may be generated. The wear threshold may be in terms of displacement of the stud or the corresponding calculated wear. The maintenance message may be generated by the ECU. The maintenance message may be provided to an owner of the vehicle such as, via a dashboard display or remote monitoring interface.

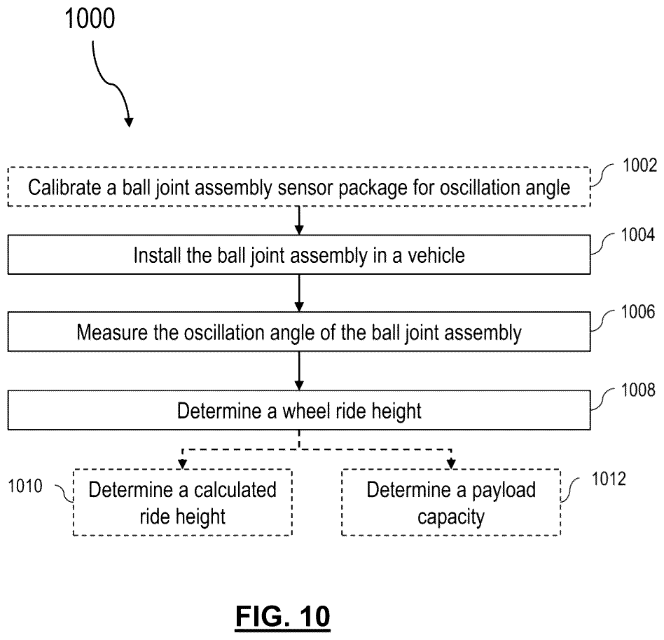

Referring to FIG. 10, shown therein is a flow diagram 1000 of a method of determining the ride height of a vehicle at various points, according to an embodiment. The ride height of the vehicle is determined based on the oscillation angle of a ball joint assembly. The ball joint assembly may be the ball joint assembly 102 of FIG. 1. The oscillation angle of the ball joint assembly may be used to determine various ride heights/and or load capacity of the vehicle.

At 1002, determining the ride height may include calibrating a sensor package of the ball joint assembly for oscillation angles. The sensor package may be the sensor package 130 of FIG. 1. Calibrating the sensor package for oscillation angle includes deriving a calibration equation for the ball joint assembly. The calibration equation is derived by disposing the ball joint assembly in a calibration device. The calibration device disposes the stud at various reference oscillation angles. In some embodiments, the calibration device oscillates the ball joint assembly in various planes. The magnetic field value at the reference oscillation angles is measured and reported. The magnetic field values are used to determine a correlation between the reference oscillation angles and the reported magnetic field values. The calibration equation is derived based on the correlation.

In some embodiments, the calibration equation is derived by obtaining an oscillation angle correlation for the ball joint assembly being calibrated. In some embodiments the calibration equation is derived by obtaining an oscillation angle correlation of a first ball joint assembly and applying the corresponding calibration equation to a second ball joint assembly of similar configuration. For example, first ball joint assembly and second ball joint assembly may be ball joint assemblies of the same dimensions, batch, model, or line of ball joint assemblies.

At 1004 determining the ride height includes installing the ball joint assembly on a vehicle. The vehicle may be the vehicle 100 of FIG. 1. Specifically, the ball joint assembly is installed as part of a suspension assembly of the vehicle. Installing the ball joint assembly may include communicatively connecting the sensor package of the ball joint assembly to an ECU of the vehicle.

At 1006 determining the ride height further includes measuring the oscillation angle of the ball joint assembly. The measuring is via the sensor package. In some embodiments, the measuring is of a sensor voltage. The sensor voltage is induced in the sensor by fluctuations in a magnetic field of sensor package. The fluctuations indicate the oscillation angle of the stud. The measuring may be at regular intervals and/or triggered by various events, such as starting the vehicle. The measuring may occur while the vehicle is in use (i.e. in transit). The sensor package encodes the measured oscillation angle value in a signal. The measured oscillation angle value may be encoded as a magnitude of the sensor voltage.

At 1008, determining the ride height further includes determining a wheel ride height. It is expressly contemplated that calculating the wheel ride height does not necessarily include calculating a wheel ride height value. For example, calculating the wheel ride height may be calculating if the wheel ride height is approaching or exceeds a wheel ride height threshold. The wheel ride height is the ride height of the vehicle at the ball joint assembly. The wheel ride height may be wheel ride height 780 of FIG. 7.

In some embodiments, determining the wheel ride height includes obtaining a calibrated ball joint assembly oscillation angle by applying the measured oscillation angle values, sensor voltage, and/or magnetic field fluctuation values to a calibration equation. The calibration equation may be the calibration equation derived at 1002. Which value is applied is based on the expected input of the calibration equation. A calibrated ball joint assembly oscillation angle, a corresponding suspension assembly ride height, and/or a corresponding wheel ride height is determined as a result of the application.

In some embodiments the calculations are performed by a PCB of the corresponding ball joint assembly, particularly a microchip of the PCB. In these embodiments, the PCB calculates the calibrated oscillation angle of the corresponding ball joint assembly, the wheel ride height, and/or a wheel payload based on the measured oscillation angle (i.e. sensor voltage).

The PCB initiates a message indicating the measured oscillation angle, calibrated oscillation angle, wheel ride height, and/or wheel payload. The PCB sends a signal including at least one message to the ECU. The signal may be sent through a CAN Bus network to the ECU.

At 1010 the determining the ride height may further include determining a calculated ride height. The calculated ride height may be the calculated ride height 782 of FIG. 7. Determining the calculated ride height includes calculating the ride height based on a measured oscillation angle, calibrated oscillation angle, wheel ride height, or wheel payload determined at 1008 and the geometry of the vehicle and/or at least one additional wheel ride height determined at 1008.

The ECU may inform the driver based on the calculated ride height. For example, a warning message may be generated based on a ride height threshold being approached or reached. The threshold may be predetermined, such as a ground clearance threshold. The threshold may be externally provided such as from a transmitter configured to provide road conditions. The warning message may be generated by the ECU. The message may be provided to an owner of the vehicle, for example via a dashboard display or remote monitoring interface.

At 1012, determining the ride height may further include determining a payload capacity of the vehicle. The payload capacity may be the payload capacity 784 of FIG. 7. Determining the payload capacity includes calculating the payload capacity based on a measured oscillation angle, calibrated oscillation angle, a wheel ride height, or a wheel payload determined at 1008 and a payload correlation, the geometry of the vehicle and/or at least one additional ride height determined at 1008.

The ECU may inform the driver based on the calculated ride height. For example, a warning message may be generated based on a payload capacity threshold being approached or reached. The threshold may be predetermined, such as a maximum payload capacity of the vehicle. The warning message may be generated by the ECU. The message may be provided to an owner of the vehicle for example, via a dashboard display or remote monitoring interface.

While the above description provides examples of one or more apparatus, methods, or systems, it will be appreciated that other apparatus, methods, or systems may be within the scope of the claims as interpreted by one of skill in the art.

1. A sensor package disposed in a ball joint assembly, the sensor package comprising:
a magnet at a first ball joint assembly component of the ball joint assembly, the magnet having a magnetic field; and
a sensor at a second ball joint assembly component of the ball joint assembly, the sensor measuring fluctuations in the magnetic field, wherein the fluctuations indicate one or more of an oscillation and a displacement of the first ball joint assembly component relative to the second ball joint assembly component.

2. The sensor package of claim 1, wherein the first ball joint assembly component comprises a stud and the second ball joint assembly component comprises a socket, the stud and socket rotatably connected.

3. The sensor package of claim 1, wherein the sensor package is contained within a cavity of the ball joint assembly.

4. The sensor package of claim 1 further comprising a printed circuit board (PCB) physically and communicatively connected to the sensor and disposed within the cavity, the PCB configured to:
receive an output of the sensor indicating the measured fluctuations; and
encode a signal based on at least on of the measured fluctuations, the signal comprising one or more of:
at least one of the measured fluctuations;
one or more of a wear and displacement of the ball joint assembly determined based on at least one displacement fluctuation encoded in the signal wherein the displacement fluctuation is a fluctuation value of the measured fluctuations indicating the displacement of the first ball joint component relative to the second ball joint component; and
one or more of a ride height of a vehicle at a suspension assembly of the vehicle comprising the ball joint assembly and an oscillation angle of the ball joint assembly determined based on at least one oscillation angle fluctuation encoded in the signal wherein the oscillation angle fluctuation is a fluctuation value of the measured fluctuations indicating the oscillation of the first ball joint assembly component relative to the second ball joint assembly component.

5. The sensor package of claim 4, wherein determining the wear comprises applying the displacement fluctuation to a displacement calibration equation.

6. The sensor package of claim 4, wherein determining the ride height at the suspension assembly comprises applying the oscillation fluctuation to an oscillation angle calibration equation.

7. The sensor package of claim 4, wherein the PCB is further configured to determine one or more of a ride height of the vehicle at a point of interest and a payload capacity of the vehicle based on the ride height at the suspension assembly.

8. The sensor package of claim 1, wherein the ball joint assembly is disposed in a vehicle, the sensor package is communicatively connected to an electronic control unit (ECU) of the vehicle, and the sensor package is configured to:
encode a signal based on the measured fluctuations, the signal indicating one or more of a wear of the ball joint assembly, a ride height of the vehicle, and a payload capacity of the vehicle one or more of approaching and exceeding a wear threshold, a predetermined ride height range and a predetermined maximum load capacity, respectively; and
provide the signal to the ECU for generating a warning message based on the signal.

9. A method of determining a disposition of a ball joint assembly wherein the ball joint assembly comprises a sensor package disposed in the ball joint assembly, the method comprises:
installing the ball joint assembly in a vehicle; and
measuring, with the sensor package, one or more fluctuations indicating one or more of a displacement and an oscillation of the ball joint assembly.

10. The method of claim 9, wherein the sensor package comprises:
a magnet at a first ball joint assembly component of the ball joint assembly, the magnet having a magnetic field; and
a sensor at a second ball joint assembly component of the ball joint assembly, the sensor measuring fluctuations in the magnetic field, wherein the fluctuations indicate an oscillation or displacement of the first ball joint assembly component relative to the second ball joint assembly component.

11. The method of claim 9 further comprising encoding a signal based on at least one measured fluctuation, the signal comprising one or more of:
the at least one measured fluctuation;
one or more of a wear and displacement of the ball joint assembly determined based on at least one displacement fluctuation encoded in the signal wherein the displacement fluctuation is a fluctuation value of the measured fluctuations indicating the displacement of the first ball joint component relative to the second ball joint component; and
one or more of a ride height of a vehicle at a suspension assembly of the vehicle comprising the ball joint assembly and an oscillation angle of the ball joint assembly determined based on at least one oscillation angle fluctuation encoded in the signal wherein the oscillation angle fluctuation is a fluctuation value of the measured fluctuations indicating the oscillation of the first ball joint assembly component relative to the second ball joint assembly component.

12. The method of claim 11 further comprising providing the signal to an ECU of the vehicle.

13. The method of claim 11 wherein at least one of the wear, displacement, ride height at the suspension assembly and oscillation angle is calculated by a PCB of the sensor package.

14. The method of claim 11, wherein calculating one or more of the wear, displacement, oscillation angle, ride height at the suspension assembly, ride height at a point of interest, and payload capacity comprises applying at least one fluctuation to a calibration equation.

15. The method of claim 9 further comprising generating a warning message based on a measured fluctuation indicating one or more of the wear, a ride height of the vehicle, and a payload capacity of the vehicle one or more of approaching and exceeding a wear threshold, a predetermined ride height range and a predetermined maximum load capacity, respectively.

16. The method of claim 15 wherein the message is generated by an ECU of the vehicle.

17. The method of claim 9, wherein the first ball joint assembly component comprises a stud and the second ball joint assembly component comprises a socket the stud and socket rotatably connected.

18. The method of claim 9, wherein the sensor package is contained within a cavity of the ball joint assembly.

19. The method of claim 9 wherein the ball joint assembly rotatably connects a first and second suspension component of a suspension assembly of the vehicle, the method further comprising determining an oscillation of the suspension assembly based on the measured oscillation.

20. The method of claim 9 further comprising determining one or more of a payload capacity of the vehicle and ride height or the vehicle at a point of interest based on at least one ride height at a suspension assembly of the vehicle.
